(19) United States
(12) Patent Application Publication
(10) Pub. No.: US 2014/0360146 A1
(43) Pub. Date: Dec. 11, 2014

(54) WET-LAID DUAL-LAYER AIR FILTRATION MEDIA INCLUDING A LARGE DIAMETER SYNTHETIC POLYMERIC FIBER IN A TOP LAYER THEREOF

(71) Applicant: Lydall, Inc., Manchester, CT (US)

(72) Inventors: William H. Cambo, Rollinsford, NH (US); Stephen Edward Gross, Dover, NH (US)

(73) Assignee: Lydall, Inc., Manchester, CT (US)

(21) Appl. No.: 14/299,388

(22) Filed: Jun. 9, 2014

Related U.S. Application Data
(60) Provisional application No. 61/833,143, filed on Jun. 10, 2013.

(51) Int. Cl. B01D 39/16; B01D 46/00; B01D 46/52

(52) U.S. Cl. CPC B01D 39/1623; B01D 46/521; B01D 46/0001
USPC 55/486; 427/244

(57) ABSTRACT

A wet-laid dual-layer air filtration media having a thin, lightweight top layer and a bottom layer is provided. The novel media includes a large diameter synthetic polymeric fiber in the top layer that deforms plastically and retains cohesion as a single object, while minimizing use of frangible components that become airborne upon handling. The novel media provides improved high dust holding capacity, while typically maintaining an overall lower basis weight than heretofore available media.

### CROSS-REFERENCE TO RELATED APPLICATIONS

This application claims benefit of U.S. Provisional Application No. 61/833,143 filed Jun. 10, 2013, which is incorporated herein by reference in its entirety.

### FIELD

The disclosure generally relates to a wet-laid dual-layer air filtration media having a thin, lightweight top layer and a bottom layer. The novel media includes a large diameter synthetic polymeric fiber in the top layer, which provides a high dust holding capacity and is configured with minimal frangible components.

### BACKGROUND

Filtration media that are useful in a wide variety of air filter applications, and that are particularly suitable for use in ASHRAE filters, particularly for applications including heating, refrigeration, and air conditioning filtration are known in the art. Such filtration media may be used to form Heating, Ventilation and Air Conditioning (HVAC), ASHRAE, Prefilter, HEPA, ULPA, SULPA or similar filters.

Although the ability to hold large capacities of dust is important for such filtration media and filters made therefrom, the skilled artisan is acutely aware that features considered important for such media are typically in competition. For instance, higher dust holding capacity is typically found in materials having a higher basis weight which are more expensive to make on a square foot basis.

One known media uses glass fibers to improve dust holding capacity. Although it is possible to create media with large diameter glass fibers, such fibers are typically brittle and easily break, and are generally not able to maintain their integrity as cohesive fibers (i.e. the fibers are frangible). Breakage of these fibers may lead to many irritation issues as the airborne particles become a nuisance dust to those who make and/or use the fibers. For instance, the broken fibers easily become airborne during typical manufacturing operations like slitting, pleating and assembly of finished filters. The broken fibers may then cause skin irritations because the airborne fibers typically feel itchy when they come in contact with the skin.

And, in media that attempts to substitute synthetic polymeric fibers for the glass fibers, one competing characteristic is the requirement that the media meet a certain flame retardation schema, since synthetic polymeric fibers are known to be more flammable than glass fibers. In other words, the media must qualify under certain flammability tests as will be discussed in more detail below.

As alluded to above, it is considered conventional wisdom that thicker and/or heavier media are typically better at holding higher quantities of dust. Such media, on the other hand, are typically more expensive to make . . . more material equals a heavier media, which typically means that the media costs more to make and purchase. In addition, it is not uncommon that space in which the filtration media may be placed to perform the filtration is typically limited, so having higher dust holding media may be considered beneficial to either reducing the media area in the filter or to extend the filter life.

In view of the disadvantages associated with currently available filtration media, there is a need for a media that improves dust holding capacity at lighter weight, and without compromising the comfort of those making and/or utilizing the media.

### BRIEF DESCRIPTION

An embodiment provides a media that balances the competing characteristics in a way that provides improved dust holding capacity, without sacrificing the comfort of the maker/user of the media. To that end, a wet-laid dual layer gas filtration media having large diameter synthetic polymeric fibers in a top layer thereof is provided, without conceding unacceptable flammability, pressure drop, and/or overall thickness or basis weight of the media.

### BRIEF DESCRIPTION OF THE FIGURES

A more particular description will be rendered by reference to specific embodiments thereof that are illustrated in the appended drawings. Understanding that these drawings depict only typical embodiments and are not therefore to be considered to be limiting of its scope, exemplary embodiments will be described and explained with additional specificity and detail through the use of the accompanying drawings in which:

FIG. 1 is a highly idealized cross-sectional view of the filtration media according to an aspect;

FIG. 2 is a highly idealized cross-sectional view of the filtration media according to another aspect; and

FIG. 3 is a graph of dust holding capacity based on gram dust holding/gram media versus DOP penetration (%) for media described herein as compared to prior commercially available media.

FIG. 4 is a MERV Chart showing the efficiency needed on the various particle size ranges to meet MERV requirements.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to embodiments.

### Definitions

Air filter—a device for removing particulate matter from an airstream including a mixture of gases and particulate matter.

ASHRAE—American Society of Heating, Refrigeration, and Air-Conditioning Engineers.

ASHRAE 52.2—The ASHRAE testing method for air filters that classifies filters according to minimum performance data. Results of ASHRAE 52.2 are expressed as Minimum Efficiency Reporting Value (MERV) ratings. This is widely considered to be the best method for assessing filtration performance as it is based upon minimum performance not average performance (as is the case for ASHRAE 52.1 and EN779).

Basis weight—The basis weight of a nonwoven material, such as a wet-laid, dual layer filtration media, is usually expressed in weight per unit area, for example in grams per square meter (gsm) or ounces per square foot (osf) (1 osf=305 gsm) or lbs./3000 ft² and as measured according to T.A.P.P.I.—T-410, A.S.T.M.—D-646.

Bicomponent fiber—A fiber that has been formed by extruding polymer sources from separate extruders and spun together to form a single fiber. Typically, two separate polymers are extruded, although a bicomponent fiber may encompass extrusion of the same polymeric material from separate extruders. The extruded polymers are arranged in substantially constantly positioned distinct zones across the cross-section of the bicomponent fibers and extend substantially continuously along the length of the bicomponent fibers. The configuration of bicomponent fibers can be symmetric (e.g., sheath:core or side:side) or they can be asymmetric (e.g., offset core within sheath; crescent moon configuration within a fiber having an overall round shape, and the like). The two polymer sources may be present in ratios of, for example (but not exclusively), 75/25, 50/50 or 25/75.

Binder—An adhesive material used to bind a web of fibers together or bond one web to another. The principal properties of a binder are adhesion and cohesion. The binder can be in solid form, for example a powder, film or fiber, in liquid form, for example a solution, dispersion or emulsion or in foam form.

Differential pressure—the resistance of a filtration media to the flow of a fluid through it. The pressure drop of a filter is a measure of the resistance the filter has to the air flow through it. Differential pressure is directly proportional to the air velocity at which it is measured.

DOP Penetration %—is the penetration of a 0.3 micron particle through a filter media, tested at a face velocity of 5.33 cm/sec, measured as a percentage according to MIL-STD-282 and A.S.T.M.—D2986-91. Efficiency, %—100-DOP Penetration, %.

Dust holding capacity (DHC)—a measure of the life of the filter. It is usually defined as the weight of dust per area that a filter will hold before the pressure drop across the filter reaches a given level at a given air face velocity.

Face Velocity—the velocity of the air moving thru the media expressed as cm/sec, ft./min. etc.

Fiber—a material form characterized by an extremely high ratio of length to diameter. As used herein, the terms fiber and filament are used interchangeably unless otherwise specifically indicated.

Filter media—the material used in a filter that makes up the filter element.

Flammability—in accordance with MVSS-302, ASTM D5132-04, UL Class 2 and ISO 3795:1989.

Frazier—The rate of airflow through a material under a constant differential pressure between the two media surfaces. The rate is measured generally in accordance with ASTM D737-75. Units are cubic feet per square foot of sample per minute (1 cf/sqf/min=5.08 1/m.sup.2/s and the differential pressure is 0.5″ water gauge (WG) (124.5 Pascal).

HEPA—High Efficiency Particulate Air filter. A HEPA filter must achieve a minimum efficiency of 99.97% on 0.3 micron particles to be called a HEPA as per ASHRAE standards.

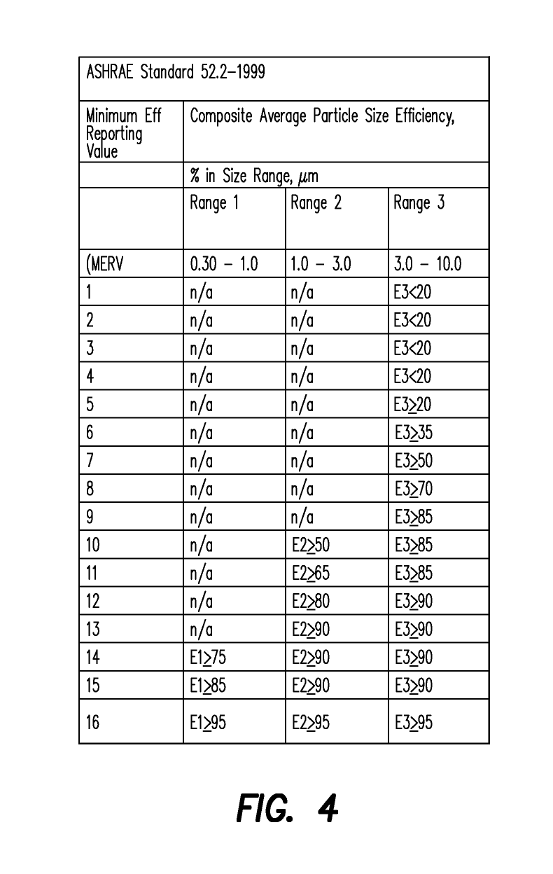

MERV—Acronym for Minimum Efficiency Reporting Value—obtained from full ASHRAE 52.2 1999 test report. The number is obtained by comparison of test data to a MERV Chart. (See, e.g., FIG. 4.) For example, a MERV11 is a value for a filter in which the average minimum efficiencies for the test composite on range 2 (1-3 micron) and range 3 (3-10 micron) have a minimum efficiency of 65 and 85%, respectively. Refer to the attached MERV Chart in FIG. 4 showing minimum efficiency for the various MERV ratings. “Estimated MERV” is determined from initial flatsheet media performance as an extrapolation of the data based on the equivalent face velocity to the pleated filter.

Micron (micrometer)—one millionth of a meter (mm). Equal to 1/25,400th of an inch.

Resistance—is a measure of the pressure drop across the filter media when tested according to MIL-STD-282, A.S.T.M.—D2986-91. SULPA—Super Ultra Low Penetration Air filter.

Synthetic polymeric fiber—is a fiber comprising, synthetic, non-natural fibers made from synthetic, non-natural polymers.

Thickness—is determined according to TAPPI T 411 om-89, “Thickness (caliper) of paper, paperboard, and combined board” using an electronic caliper microgauge 3.3 Model No. 49-62 manufactured by TMI with a foot pressure of 7.3 psi.

ULPA—Ultra Low Penetration Air filter.

### DETAILED DESCRIPTION

Reference will now be made in detail to various embodiments. Each example is provided by way of explanation, and is not meant as a limitation and does not constitute a definition of all possible embodiments.

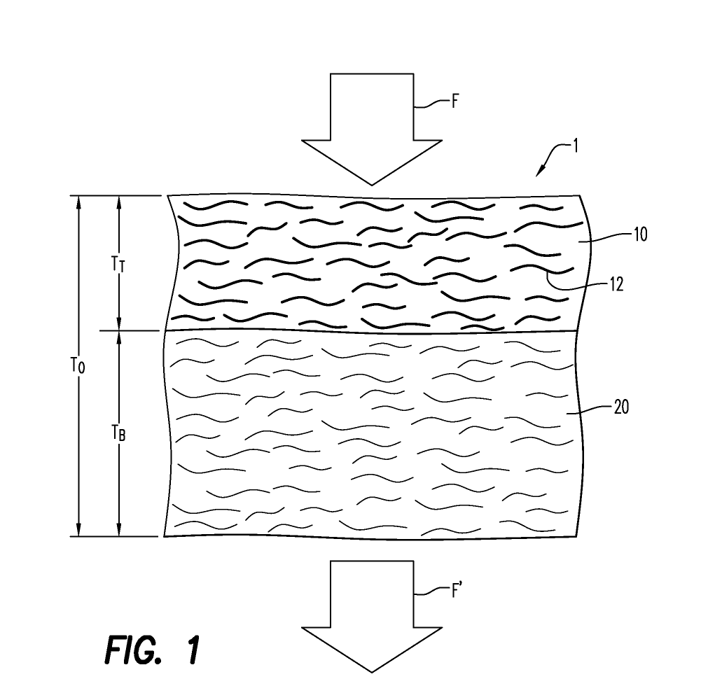

In an embodiment, a wet-laid, dual layer air filtration media and a method for making the filtration media is provided. With reference to FIG. 1, according to an embodiment, a filtration media 1 is provided that includes a top or air-entry layer 10 and a bottom or air-exit layer 20 shown attached to the top layer 10, wherein an airstream including particulate matter F is shown passing through the filter media 1 beginning at the top layer 10 and passing through and exiting the bottom layer 20 as F′, air that has been at least somewhat stripped of particulate matter. According to an aspect, the filtration media is configured to remove dust from the airstream with the dustholding layer on the upstream side and the efficiency layer on the downstream side to extend filter life.

The top layer 10 includes at least 2-100 wt % synthetic polymeric fibers 12, preferably about 12.6-90 wt. %, and more preferably about 10-20 wt. %. In an embodiment, the synthetic polymeric fiber 12 deforms plastically and retains cohesion as a single object, unlike the large diameter glass fibers that are traditionally used and which are frangible components that easily become airborne upon handling, (such as during pleating), leading to skin irritations. Configured according to an aspect, the top layer has a low tendency to shed fibers. In any case, the top layer 10 is preferably configured with minimal frangible components that become airborne upon handling.

The synthetic polymeric fiber is made from one or more of the following polymers: polyester, nylon, acrylic, modacrylic, and polyolefin. It is also contemplated that the synthetic polymeric fiber includes a semi-synthetic polymeric fiber such as rayon. Preferably, the synthetic polymeric fiber is made from one or more of the following polymers: polylactide (PLA), polyethylene, polypropylene, polyethylene terephthalate.

In a preferred embodiment, the synthetic polymeric fiber 12 includes at least one of bicomponent fibers, shaped fibers, crimped fibers and hollow fibers. In an embodiment, the synthetic polymeric fiber is a low melt sheath/core bicomponent fiber. Without intending to be bound by the theory, it is believed that large diameter, (as discussed in more detail herein below), low melt sheath/core bicomponent fibers at least partially melt during fabrication of the media, and thus provide a tie down affect to fibers forming the top layer.

In an embodiment, the synthetic polymeric fiber 12 is selected from fibers having a “large” diameter. By “large diameter” it is meant that the synthetic polymeric fiber has a diameter of at least about 6-50 microns, preferably about 15.9-50 microns, and more preferably about 10-20 microns.

As shown in FIG. 1, the top layer 10 is thinner (having a thickness T_{T}) than the bottom layer 20 (having a thickness T_{B}), wherein the total thickness of the filtration media 1 is shown as T_{O}. In other words, T_{T}+T_{B}−T_{O}. In an embodiment, the media 1 has a total thickness T₀ of at least about 14-17 mils and the top layer 10 has a thickness T_{T} of less than about 30% of the total media thickness T_{O}, preferably less than about 20%, and more preferably less than about 15%. In this way, a thin top layer is provided as compared to the total thickness of the overall media.

In an embodiment, the top or air entry layer 10 of the filtration media 1 has an average pore size that is configured to filter larger particles from the air stream F being filtered, thus allowing smaller particles to pass through to the bottom or air exit layer 20 for further filtration.

According to an aspect, the filtration media 1 may be provided as a dual layer media, but one that has an overall lower basis weight than known dual layer filtration media. One distinct advantage of lower basis weight is that the overall cost of the media is reduced—less material equals less weight equals lower cost. In an embodiment, the overall basis weight of the filtration media is about 38-50 lbs./3000 ft², and preferably about 40-44 lbs./3000 ft². In an embodiment, the top layer makes up less than about 20% of the overall media basis weight, preferably between about 1-20%.

The bottom layer 20 is made of any typical materials as would be understood by one of ordinary skill in the art, although the composition of the bottom layer is preferably not the same as the composition of the top layer and contains finer sub-micron fibers to meet efficiency requirements. The DOP penetration is controlled by the downstream efficiency layer and will vary by the amount of fine submicron glass microfibers to meet MERV rating requirements. Typically the lower MERV Rated media use less submicron fiber and have higher dust holding capacity.

The filtration media 1 according to an aspect exhibits a dust holding capacity of at least about 34-37.4 g/m2 at about a 38% DOP Penetration using ISO Fine test dust. These media are considered highly efficient and can thus achieve MERV ratings of at least about 11 up to about 15.

As would be understood by one of ordinary skill in the art, it is sometimes important that the filtration media pass certain flammability tests and/or standards. As also understood, typically, the higher the content of synthetic polymeric fibers in the media, the higher the flammability. In other words, media having high content of synthetic polymeric fibers typically burn too easily, and thus are not suitable for certain applications. According to an aspect, although the top layer of the filtration media having at least 2% synthetic polymeric fiber, the top layer will also have sufficient non-synthetic polymeric fibers in the top layer to pass the applicable flammability test. The total organic content of the media including synthetic fiber, binder and water repellant can be increased to 13% and still meet UL Class 2 for flammability in the finished filter.

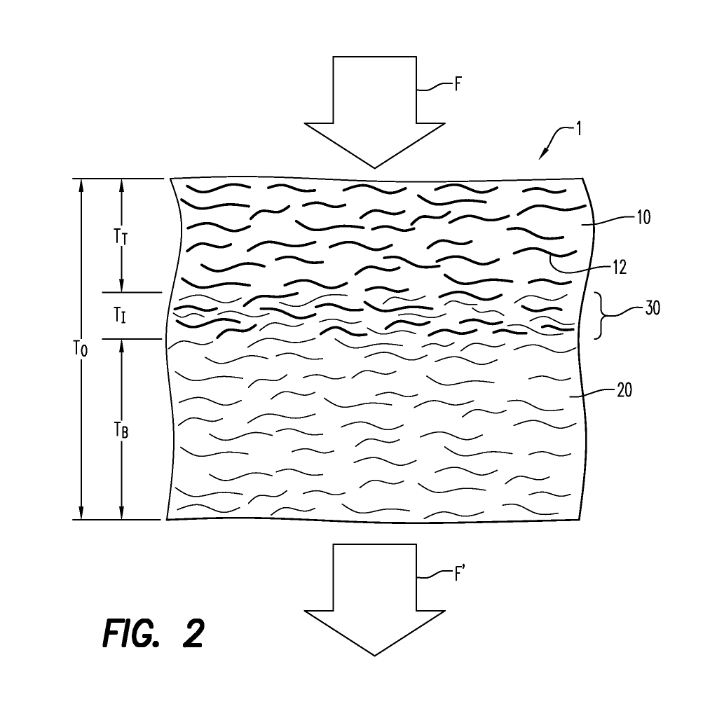

Turning to FIG. 2, another filtration media 1 is provided in which formation of the top layer 10 upon the bottom layer 20 results in a gradient interface layer 30 being formed between the top layer 10 and the bottom layer 20. In other words, the interface layer 30 results from a partial mixing of the top and bottom layer such that there is a less discrete separation of the top layer 10 and the bottom layer 20, providing for a gradient structure of pore sizes. As shown in FIG. 2, the gradient interface layer 30 has a thickness T_{I} that is less than the thickness of the top layer T_{T} and the thickness of the bottom layer T_{B}. As shown herein, the total layer thickness T_{O} is equal to T_{T} plus T_{I} plus T_{B}.

While methods of making wet-laid, dual-layer filtration media are well known by those of ordinary skill in the art, it is believed that depositing the bottom layer onto a forming belt, followed by depositing the top layer atop the bottom layer may result in at least partially mixing the top and bottom layers to form the interface layer 30, which may have certain advantages as discussed in more detail above.

Yet another advantage of the presently presented filtration media lies in the fact that the media may be formed into a pleated assembly without serving as an irritant to those handling or using the material. It is well known, that pleating the media into various configurations is difficult to manage, (particularly when done automatically on a pleating machine), when large quantities of glass fiber are incorporated into the media, because of the frangibility of these glass fibers. The media is configured with minimal frangible components that become airborne upon handling, meet UL Class 2 in the finished filter, while also providing improved dust holding capacity.

### EXAMPLES

According to an aspect, Sample A was made as follows: the top layer was 11.11 wt. % of the total basis weight of the media, while the bottom layer was 88.89 wt. %. The top layer included 9.49 wt. % ⅛″ DE chopped strand (glass) fiber (commercially available from PPG), 0.27 wt. % KURALON™ 105-2×5 mm fiber (commercially available from Kuraray America Inc.) and 1.35 wt. % EZBON-L™ 2.5 dpf×6 mm bicomponent polyester (a sheath/core (LM PET/Reg. PET) fiber having a melting point of 110° C., having a diameter of 15.9 microns commercially available from Saehan Industries, Inc.), while the bottom layer included 19.22 wt. % ¼″ DE chopped strand (glass) fiber, 57.65 wt. % JM 112X glass microfiber (commercially available from Johns Manville), 0.62 wt. % KURALON™ 105-2×5 mm fiber, and 11.40 wt. % JM 106 glass microfiber (also available from Johns Manville).

In another example, Sample B was made as follows: the top layer was 10.90 wt. % of the total basis weight of the media, while the bottom layer was 89.10 wt. %. The top layer included 9.31 wt. % ⅛″ DE chopped strand (glass) fiber, 0.26 wt. % KURALON™ 105-2×5 mm fiber and 1.33 wt. % EZBON-L™ 2.5 dpf×6 mm bicomponent polyester, while the bottom layer included 18.45 wt. % ¼″ DE chopped strand (glass) fiber, 55.35 wt. % JM 112X glass microfiber, 0.60 wt. % KURALON™ 105-2×5 mm fiber, and 14.70 wt. % JM 106 glass microfiber.

As set out in Table 1 below, various samples of each of Sample A and B were tested as set forth in the table, wherein it is seen that improved dust holding capacity was found in materials having a low basis weight, and wherein the top layer of the media is thin and lightweight as compared to the media as a whole.

TABLE 1

| | Sample | | | | | | | |
|---|---|---|---|---|---|---|---|---|
| | A1 | A2 | A3 | A4 | B1 | B2 | B3 | B4 |
| Basis Weight | 44.5 | 42.8 | 41.74 | 40.5 | 45.51 | 45.82 | 44.26 | 44.2 |
| (lbs/3000 ft²) | | | | | | | | |
| DOP Penetration, | 36.9 | 36.5 | 38.1 | 39.6 | 44.8 | 43.4 | 53.5 | 52.6 |
| (%) | | | | | | | | |
| Media Thickness | 14.2 | 16 | 15.4 | 16 | 16.8 | 16.3 | 16.3 | 16 |
| (mils) | | | | | | | | |
| DHC (g/m²) | 35.7 | 36.1 | 34.5 | 37.3 | 37.8 | 36.7 | 40.8 | 42.1 |
| DHC (g-dust/g- | 0.495 | 0.521 | 0.510 | 0.569 | 0.513 | 0.494 | 0.569 | 0.588 |
| media) | | | | | | | | |

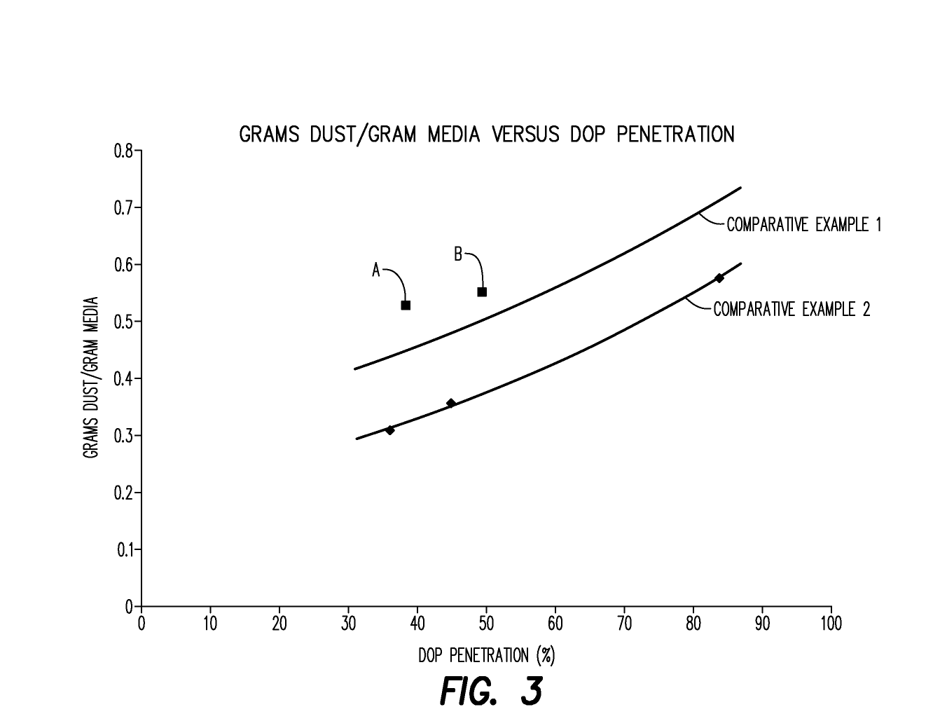

Comparative examples were also created and tested as set forth in Table 2 below, and as plotted in FIG. 3. Comparative Example 1 was a product line of 48 lb./3000 ft2 dual layer filtration media commercially available as Lydair grades 1306, 1296 and 1247, and a curve plotting grams of dust/grams basis weight of the media against the DOP % for three data points having a trendline described by the function y=0.305e^{0.0101x}, and R²=0.999. Comparative Example 2 was a single layer grade line of filtration media commercially available as Lydair grades 1923, 1894 and 1909, its curve having a trendline described by the function y=0.1968e^{0.0128x}, and R²=0.998.

TABLE 2

| | Dual Layer | | | Single Layer | | |
|---|---|---|---|---|---|---|
| | Grade | | | | | |
| | Lydair 1306 | Lydair1296 | Lydair1247 | Lydair1923 | Lydair1894 | Lydair1909 |
| | 1A | 1B | 1C | 2A | 2B | 2C |
| Basis | 49.5 | 49.2 | 48.4 | 44.2 | 42.0 | 38.2 |
| Weight | | | | | | |
| (lbs/3000 ft²) | | | | | | |
| DOP (%) | 31.4 | 49.1 | 87.0 | 38.2 | 45.1 | 83.9 |
| Media | 14.4 | 14.4 | 16.1 | 12.7 | 12.3 | 11.9 |
| Thickness | | | | | | |
| (mils) | | | | | | |
| DHC (g/m2) | 33.75 | 39.6 | 57.7 | 22.1 | 24.3 | 35.6 |
| DHC (g- | 0.421 | 0.496 | 0.736 | 0.309 | 0.357 | 0.576 |
| dust/g-media | | | | | | |

The components and methods illustrated are not limited to the specific embodiments described herein, but rather, features illustrated or described as part of one embodiment can be used on or in conjunction with other embodiments to yield yet a further embodiment. It is intended that all such modifications and variations are included. Further, steps described in the method may be utilized independently and separately from other steps described herein.

While the components and methods have been described with reference to a preferred embodiment or preferred embodiments, it will be understood by those skilled in the art that various changes may be made and equivalents may be substituted for elements thereof without departing from the intended scope. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment,” “an embodiment,” and the like, are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “up”, “down”, etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose components and methods, including the best mode, and also to enable any person of ordinary skill in the art to practice the components and methods, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A wet-laid dual-layer gas filtration media, comprising:
a top layer, said top layer comprising about 2-100 wt. % synthetic polymeric fiber, wherein the synthetic polymeric fiber is a polymer material that deforms plastically and retains cohesion as a single object, and wherein the diameter of the synthetic polymeric fiber is about 6-50 microns; and
a bottom layer,
wherein the media has a basis weight of about 38-50 lbs./3000 ft² and a dust holding capacity of at least about 34 g/m² at about a 38% DOP penetration, the top layer has a basis weight of about 5-20% of the media basis weight and is configured with minimal frangible components that become airborne upon handling.

2. The media of claim 1, wherein the synthetic polymeric fiber comprises at least one of bicomponent fibers, shaped fibers, crimped fibers and hollow fibers.

3. The media of claim 1, wherein the diameter of the synthetic polymeric fiber is at least about 15.9-50 microns.

4. The media of claim 1, wherein the synthetic polymeric fiber is selected from the group comprising polyester, nylon, acrylic, modacrylic, polyolefin, or combinations thereof.

5. The media of claim 1, further comprising a semi-synthetic polymeric fiber, such as rayon.

6. The media of claim 1, wherein the top layer comprises about 10-90 wt. % synthetic polymeric fiber.

7. The media of claim 1, wherein the synthetic polymeric fiber is selected from the group comprising polylactide (PLA), polyethylene, polypropylene, polyethylene terephthalate, or combinations thereof.

7. The media of claim 1, wherein the top layer has a low tendency to shed fibers.

8. The media of claim 1, wherein the media has a MERV rating of at least about 11-15.

9. The media of claim 1, wherein the synthetic polymeric fiber is a low melt sheath/core bicomponent fiber.

10. The media of claim 9, wherein the low melt sheath/core bicomponent fiber provides a tie down affect to fibers of the top layer.

11. The media of claim 1, wherein the media has a basis weight of about 40-44 lbs./3000 ft².

12. The media of claim 1, wherein the media has a total thickness of at least about 14 mils and the top layer has a thickness of less than about 30% of the media thickness.

13. The media of claim 1, wherein the composition of the bottom layer is not the same as the composition of the top layer.

14. A pleated assembly comprising the media of claim 1.

15. A wet-laid dual-layer gas filtration media, comprising:
a top layer, said top layer comprising synthetic polymeric fiber, wherein the synthetic polymeric fiber is a polymer material that deforms plastically and retains cohesion as a single object, and wherein the diameter of the synthetic polymeric fiber is about 6-50 microns; and
a bottom layer,
wherein the media has a basis weight of about 38-50 lbs./3000 ft² and a dust holding capacity of at least about 34 g/m² at about a 38% DOP Penetration, the top layer has a basis weight of about 1-20% of the media basis weight and is configured with minimal frangible components that become airborne upon handling, the media comprising sufficient non-synthetic polymeric fiber in the top layer to pass a flammability test.

16. A method of making the wet-laid dual-layer gas filtration media of claim 1, comprising:
depositing the bottom layer onto a forming belt;
depositing the top layer atop the bottom layer in a way that at least partially mixes the top and bottom layers to form a gradient interface layer between the top and bottom layer.
